(19) United States
(12) Patent Application Publication
(10) Pub. No.: US 2013/0321315 A1
(43) Pub. Date: Dec. 5, 2013

(54) METHOD AND APPARATUS FOR INPUTTING A CHARACTER IN A TOUCH KEYPAD

(71) Applicant: Samsung Electronics Co., Ltd., Gyeonggi-do (KR)

(72) Inventors: Won-Suk Chang, Gyeonggi-do (KR); Do-Hyeon Kim, Suwon-si (KR); Hee-Bum Ahn, Seoul (KR); Dong-Chang Lee, Daegu (KR); Dong-Hyuk Lee, Seoul (KR)

(21) Appl. No.: 13/909,725

(22) Filed: Jun. 4, 2013

(30) Foreign Application Priority Data
Jun. 4, 2012 (KR) 10-2012-0059809

(51) Int. Cl. G06F 3/041

(52) U.S. Cl. CPC G06F 3/041
USPC 345/173

(57) ABSTRACT

A method and apparatus for inputting characters using a touch keypad with a plurality of keys are provided, in which upon detection of a user's touch on one of the plurality of keys, a character corresponding to the touched key is acquired, a pop-up character set is generated using the acquired character and a character which has been completely input before the user's touch and displayed in an input character display area, and a touch pop-up including the pop-up character set is displayed in the vicinity of the touched key.

### PRIORITY

This application claims priority under 35 U.S.C. §119(a) to a Korean Patent Application filed in the Korean Intellectual Property Office on Jun. 4, 2012 and assigned Serial No. 10-2012-0059809, the contents of which are incorporated herein by reference.

### BACKGROUND OF THE INVENTION

1. Field of the Invention

The present invention relates to a digital portable device having a touch screen, and more particularly, to a method and apparatus for inputting characters using a touch keypad displayed on a touch screen.

2. Description of the Related Art

Along with the advent of the digital era, a large number of digital portable devices have touch screens. A touch screen is an input device that allows a user to input a character or symbol by touching it on a screen with the user's finger. The touch screen is configured by covering a transparent film-type input device over a display. For input detection on the touch screen, a position is determined by arranging detection lines in grids, a variation in the potential of the film is detected, or a position is determined by blocking infrared rays or ultrasonic waves that have been emitted in grids.

For character input, a device having such a touch screen provides a touch keypad with a plurality of letter or number keys. When a user inputs a character using the touch keypad, the user has difficulty in determining whether a key has been input in a tactile manner. As a result, the touch keypad suffers from a high character input error rate and a low input speed, compared to a physical keyboard. In this context, attempts have been made to overcome the shortcomings of the touch keypad in a visual fashion.

To prevent a decrease in the accuracy and speed of character input using a touch keypad, conventionally a character corresponding to a key that a user has touched on the touch keypad pops up in the vicinity of the key, as illustrated in FIG. 1. FIG. 1 illustrates sequential character input screens in a conventional process of inputting characters on a touch keypad.

Referring to FIG. 1, a character input screen 10 includes a touch keypad 70, an input character display area 50, and a touch pop-up 60.

When a user selects and touches a specific key, for example, a key to which a consonant “ [symbol] ” is assigned on the touch keypad 70, a portable device displays a touch pop-up 60 including the letter corresponding to the touched key, that is, the consonant “ [symbol] ”. When the user discontinues touching the specific key, the letter displayed in the touch pop-up 60 is displayed in the input character display area 50 on a second screen 20. When the user later selects a key to which a vowel “ [symbol] ” is assigned, a touch pop-up 60 including the vowel “ [symbol] ” is displayed. Subsequently, when the user discontinues the touch on the key corresponding to the vowel “ [symbol] ”, a character “ [symbol] ” is displayed in the input character display area 50 on third screen 30 by adding the vowel “ [symbol] ” displayed in the touch pop-up 60 to the consonant “ [symbol] ” displayed in the character input area 50. In a similar manner, a character “ [symbol] ” may be displayed in the character input area 50 on a fourth screen 40.

While the conventional character input method enables a user to confirm a current touched key in a touch pop-up 60, it has limitations in allowing the user to confirm input of an intended character string with information provided by the touch pop-up. If the user inputs keys successively only using information acquired from the touch pop-up, it is difficult for the user to determine if a key input is missing or there has been repeated inputs of the same key, which results in inputting a wrong character string. For accurate input of a character string, the user has to check the touch keypad and an input whole character string alternately. As a consequence, the speed of inputting a character sequence may be decreased and wrong type-ins may be increased.

### SUMMARY OF THE INVENTION

The present invention has been made to address at least the problems and/or disadvantages described above and to provide at least the advantages described below. Accordingly, an aspect of embodiments of the present invention is to provide a character input method and apparatus for increasing the accuracy and speed of character input and user convenience, when a touch keypad is used in a portable device having a touch screen.

In accordance with an embodiment of the present invention, there is provided a key input method using a touch keypad with a plurality of keys, in which upon detection of a user's touch on one of the plurality of keys, a character corresponding to the touched key is acquired, a pop-up character set is generated using the acquired character and a character which has been completely input before the user's touch and displayed in an input character display area, and a touch pop-up including the pop-up character set is displayed in the vicinity of the touched key.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 illustrates sequential character input screens in a conventional process of inputting characters on a touch keypad;

FIG. 2 is a block diagram of a portable device according to an embodiment of the present invention;

FIG. 3 is a block diagram of a touch screen unit according to an embodiment of the present invention;

FIG. 4 is a flowchart illustrating an operation of a character input processor according to an embodiment of the present invention; and

FIGS. 5 and 6 illustrate character input screens according to an embodiment of the present invention.

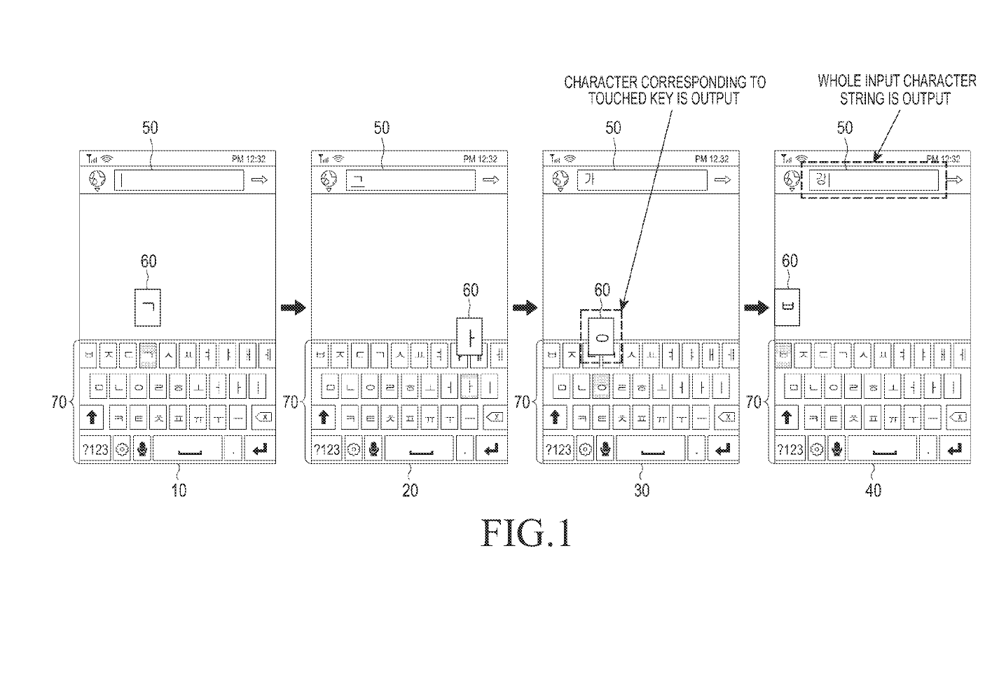

Throughout the drawings, the same drawing reference numerals will be understood to refer to the same elements, features and structures.

### DETAILED DESCRIPTION OF EMBODIMENTS OF THE INVENTION

Reference will be made to preferred embodiments of the present invention with reference to the attached drawings. A detailed description of generally known functions and structures of the present invention will be omitted to avoid obscuring the subject matter of the present invention.

The present invention provides a character input method for increasing the accuracy and speed of character input and user convenience, when a touch keypad is used in a portable device having a touch screen.

According to the present invention, upon sensing a user's touch input of a specific key on a touch keypad, a character set obtained by combining a character corresponding to the specific key and an already input character is displayed in a touch pop-up, so that the user may confirm input of intended characters.

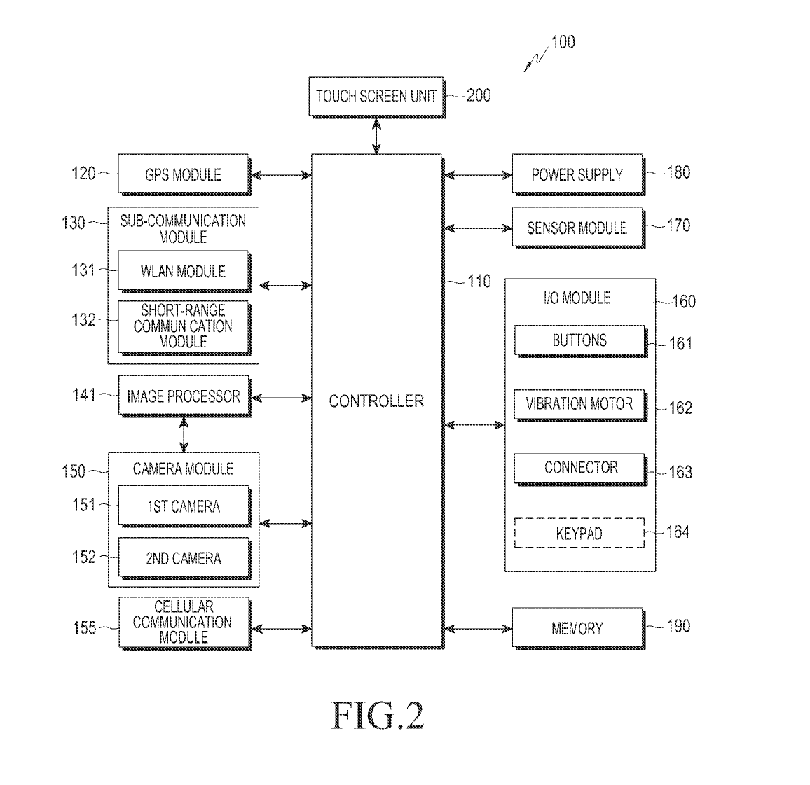

FIG. 2 illustrates a configuration of a digital portable device to which the present invention is applied. The digital portable device may be, for example, a smart phone, a portable phone, a portable game console, a Portable Multimedia Player (PMP), etc.

Referring to FIG. 2, a portable device 100 may be connected to an external device (not shown) through a cellular communication module 155, a sub-communication module 130, and a connector 163. The term “external device” covers a variety of devices such as another device of the same type (not shown), a portable phone (not shown), a smart phone (not shown), a tablet PC (not shown), and a server (not shown).

The portable device 100 includes a touch screen unit 200. The portable device 100 further includes a controller 110, an image processor 141, a camera module 150, a Global Positioning System (GPS) module 120, an Input/Output (I/O) module 160, a sensor module 170, a memory 190, and a power supply 180. The portable device 100 also includes the cellular communication module 155 and the sub-communication module 130.

The sub-communication module 130 includes at least one of a Wireless Local Area Network (WLAN) module 131 and a short-range communication module 132. The camera module 150 includes at least one of first and second cameras 151 and 152. The I/O module 160 includes at least one of buttons 161, a vibration motor 162, a connector 163, and a keypad 164.

The controller 110 is a processor that controls the operations of the portable device 100 using a ROM that stores a control program for controlling the portable device 100 and a RAM that stores externally input signals or data, or provides a memory space for operations performed in the portable device 100. The controller 110 may include a single core, dual cores, triple cores, or quad cores.

The controller 110 controls the cellular communication module 155, the sub-communication module 130, the image processor 141, the camera module 150, the GPS module 120, the I/O module 160, the sensor module 170, the memory 190, the power supply 180, and the touch screen unit 200.

The cellular communication module 155 connects the portable device 100 to an external device, for mobile communication through at least one antenna (i.e. one or more antennas) under the control of the controller 110. The cellular communication module 155 transmits and receives radio signals for voice call, video call, a Short Message Service (SMS) message, or a MultiMedia Service (MMS) message with a portable phone (not shown), a smart phone (not shown), a tablet PC, or another device (not shown), which has a phone number input to the portable device 100.

The sub-communication module 130 includes at least one of the WLAN module 131 and the short-range communication module 132. For example, the sub-communication module 130 may include the WLAN module 131 or the short-range communication module 132 alone, or both.

The WLAN module 131 is connected to the Internet in a place where a wireless Access Point (AP) (not shown) is installed, under the control of the controller 110. The WLAN module 131 supports the WLAN standard, Institute of Electrical and Electronics Engineers (IEEE) 802.11x. The short-range communication module 132 conducts wireless short-range communication between the portable device 100 and an image forming apparatus (not shown) under the control of the controller 110. The short-range communication module 132 may operate in conformance to Bluetooth, Infrared Data Association (IrDA), etc.

The portable device 100 may include at least one of the cellular communication module 155, the WLAN module 131, and the short-range communication module 132 according to its capabilities. For instance, the portable device 100 may include the cellular communication module 155, the WLAN module 131, and the short-range communication module 132 alone or in combination according to its capabilities.

The image processor 141 controls the operations of the cameras 151 and 152 under the control of the controller 110. The image processor 141 also processes the video quality of image data acquired by the image sensor and converts the format of the processed image data. The controller 110 stores the image data received from the image processor 141 in the memory 190.

The camera module 150 may include at least one of the first and second cameras 151 and 152 that capture a still image or video under the control of the controller 110. The first or second camera 151 or 152 may include an auxiliary light source (e.g. a flash (not shown)) for providing a light intensity needed for capturing an image. The first camera 151 may be disposed on the front surface of the portable device 100, whereas the second camera 152 may be disposed on the rear surface of the portable device 100. Alternately, the first and second cameras 151 and 152 may be disposed in close proximity, for capturing a 3D still image or a 3D video.

The GPS module 120 receives signals from a plurality of GPS satellites in Earth orbit and calculates the position of the portable device 100 based on the Time of Arrivals (ToAs) of the signals from the GPS satellites to the portable device 100.

The I/O module 160 includes at least one of a plurality of buttons 161, the vibration motor 162, the connector 163, and the keypad 164.

The buttons 161 may be arranged on the front surface, a side surface, or the rear surface of a housing of the portable device 100, including at least one of a Power/Lock button (not shown), a Volume button (not shown), a Menu button, a Home button, a Back button, and a Search button.

The vibration motor 162 converts an electrical signal to mechanical vibrations under the control of the controller 110. For example, upon incoming of a voice call from another device (not shown) at the portable device 100 in vibration mode, the vibration motor 162 operates. One or more vibration motors may be mounted inside the housing of the portable device 100. The vibration motor 162 may operate in response to a user's touch on a touch panel of the touch screen unit 200 and a successive movement of a touch on the touch panel.

The connector 163 may be used as an interface between the portable device 100 and an external device (not shown) or a power source (not shown). The connector 163 may transmit data stored in the memory 190 of the portable device 100 to the external device or may receive data from the external device, via a cable connected to the connector 163. Power may be received from the power source or a battery may be charged, via the cable connected to the connector 163.

The sensor module 170 includes at least one sensor for detecting a state of the portable device 100. For example, the sensor module 170 includes a proximity sensor for detecting whether a user is near to the portable device 100, a light sensor (not shown) for detecting the amount of ambient light around the portable device 100, or a motion sensor (not shown) for detecting movement (e.g. rotation, acceleration, or vibration) of the portable device 100. At least one sensor may detect a state of the portable device 100, generate a signal corresponding to the detected state, and transmit the signal to the controller 110. A sensor may be added to or removed from the sensor module 170 according to the capabilities of the portable device 100.

The memory 190 stores an input/output signal or input/output data according to an operation of the cellular communication module 155, the sub-communication module 130, the image processor 141, the camera module 150, the GPS module 120, the I/O module 160, the sensor module 170, and the touch screen unit 200 under the control of the controller 110. The memory 190 also stores a control program and applications for performing control operations of the portable device 100 or the controller 110. The memory 190 stores character combination rules and grammar for various languages.

The term “memory” covers various devices such as the memory 190, a ROM, a RAM, or a memory card (not shown, e.g. an SD card, a memory stick, etc.) installed in the portable device 100. The memory also includes a non-volatile memory, a volatile memory, a Hard Disk Drive (HDD), or a Solid State Drive (SSD).

The power supply 180 supplies power to one or more batteries (not shown) mounted in the housing of the portable device 100 under the control of the controller 110. The one or more batteries supply power to the portable device 100. The power supply 180 supplies power received from an external power source (not shown) via the cable connected to the connector 163 to the portable device 100.

The touch screen unit 200 provides User Interfaces (UIs) corresponding to a variety of services (e.g. call, data transmission, broadcasting reception, photo taking, text input, etc.) to a user and thus may include a display. The touch screen unit 200 transmits a signal corresponding to at least one touch input on a UI to the controller 110.

In particular, the touch screen unit 200 includes a character input processor for providing a character input method according to the present invention. When performing a function needed for character input, the character input processor provides a character input UI and processes a user input on the character input UI.

The character input UI includes a character display area in which completely input characters are displayed, a touch keypad having a plurality of keys, and a touch pop-up displayed near to a key touched by a user.

The touch keypad includes a plurality of keys to which characters, numbers, and/or symbols for each language are assigned. The characters may be, for example, Korean alphabet letters, English alphabet letters, etc. For helping the understanding of the present invention, it is assumed that characters cover all the letters of different languages, numbers, and symbols.

A touch pop-up refers to a pop-up window including a pop-up character corresponding to a user's touch input or a set of pop-up characters corresponding to a user's touch inputs.

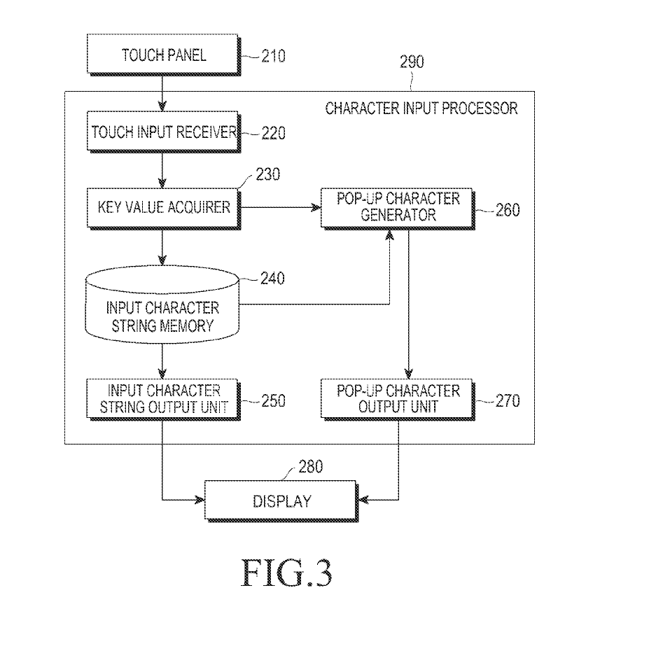

FIG. 3 is a block diagram of the touch screen unit 200 for providing a character input method according to an embodiment of the present invention. Referring to FIG. 3, the touch screen unit 200 includes a touch panel 210, a character input processor 290, and a display 280. The character input processor 290 includes a touch input receiver 220, a key value acquirer 230, a pop-up character generator 260, an input character string memory 240, a pop-up character output unit 270, and an input character string output unit 250. While the character input processor 290 is shown in FIG. 3 as being included in the touch screen unit 200, it is contemplated in another embodiment of the present invention that the character input processor 290 is incorporated into the controller 110 or configured as an independent function block in the portable device 100.

The touch panel 210 is a transparent film disposed on top of the display 280, for sensing a user's touch input and transmitting a touch input signal corresponding to the sensed touch input to the touch input receiver 220. The touch input signal includes position data of a touched point on the touch panel 210.

The touch input receiver 220 awaits reception of a user's touch input, receives a touch input signal, and outputs the touch input signal to the key value acquirer 230.

The key value acquirer 230 stores key values, i.e. characters, corresponding to a plurality of keys included in touch keypads available to the user. The key value acquirer 230 acquires a key value, i.e. a character corresponding to a user's touch input, and provides the key value, i.e. the character, to the pop-up character generator 260 or the input character string memory 240.

In other words, once a user starts to touch a specific key, the key value acquirer 230 outputs a character corresponding to the specific key to the pop-up character generator 260. When the user completes the touch input, the key value acquirer 230 outputs the character corresponding to the specific key to the input character string memory 240 and outputs a key input complete signal to the pop-up character generator 260. Completion of a touch input is identified by, for example, releasing a user's touch on a specific key without changing a touch point on the touch panel 210 or within an allowed touch point changing range. Thus, the key value acquirer 230 determines whether a touch input has been completed based on a touch input signal received from the touch input receiver 230.

If the user's touch input regarding the specific key is cancelled, the key value acquirer 230 outputs a key input cancel signal to the pop-up character generator 260. For instance, when the user touches a specific key and then moves to another touch point beyond an allowed range on the touch panel 210 without releasing the touch, the touch input is cancelled. Thus, the key value acquirer 230 determines whether a touch input has been canceled based on a touch input signal received from the touch input receiver 230.

As described above, only when a touch input regarding a specific key is completed, a character corresponding to the specific key is provided to the input character string memory 240. If the touch input is canceled or has failed for some reason, the character is not provided to the input character string memory 240.

The input character string memory 240 stores a character for which a touch input has been completed and thus which has been displayed in the input character display area. The input character string memory 240 combines the stored character, that is, the character displayed in the input character display area with the character received from the key value acquirer 230 according to a related character combination rule. Then, the input character string memory 240 outputs the combined characters to the input character string output unit 250 so that the combined characters may be displayed on the display 280, and then stores the combined characters. If it is not possible to combine an already stored character string with a character received from the key value acquirer 230 according to the character combination rule, the input character string memory 240 outputs the already stored character string and the received character in their input order to the input character string output unit 250 and stores them.

The input character string output unit 250 updates the characters received from the input character string memory 240 and displays the updated characters on a screen.

Upon receipt of a character from the key value acquirer 230, the pop-up character generator 260 reads a character stored in the input character string memory 240 and combines the received character with the read character according to a related character combination rule. The characters combined by the pop-up character generator 260 and included in a touch pop-up are referred to as a pop-up character set. The pop-up character generator 260 generates a touch pop-up including the combined pop-up characters and outputs the touch pop-up to the pop-up character output unit 270. The pop-up character output unit 270 displays the received pop-up character set near to the key touched by the user.

Upon receipt of a key input complete signal or a key input cancel signal from the key value acquirer 230, the pop-up character generator 260 outputs a pop-up display discontinuation signal to the pop-up character output unit 270.

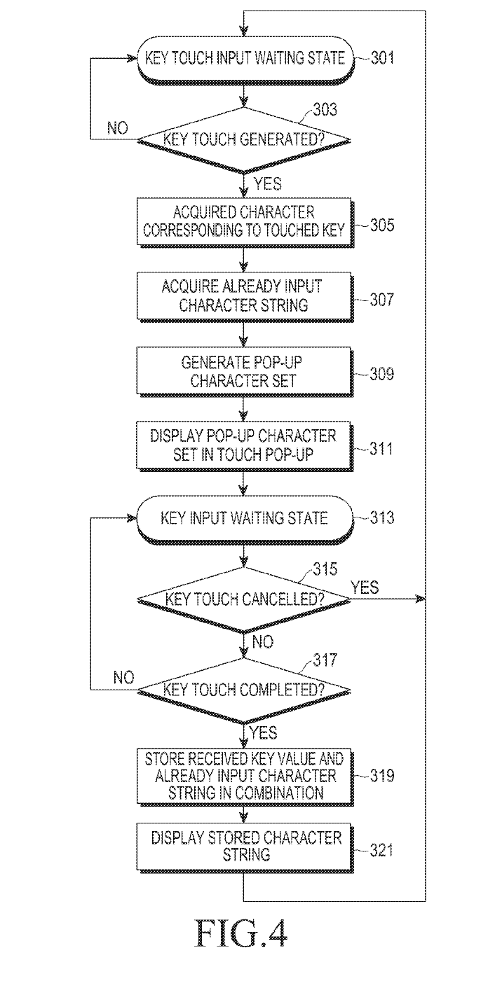

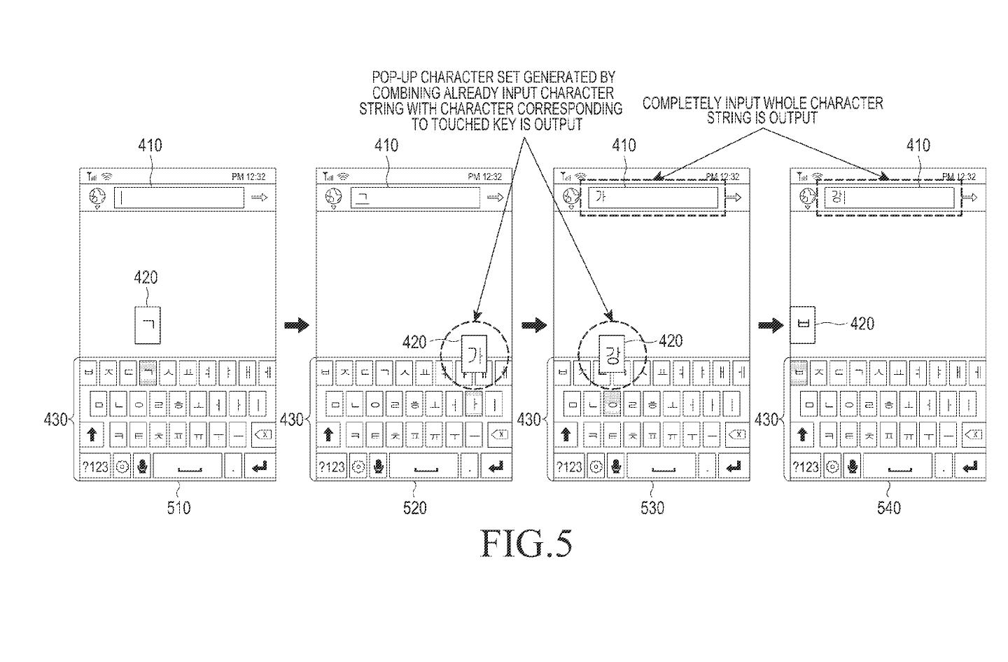

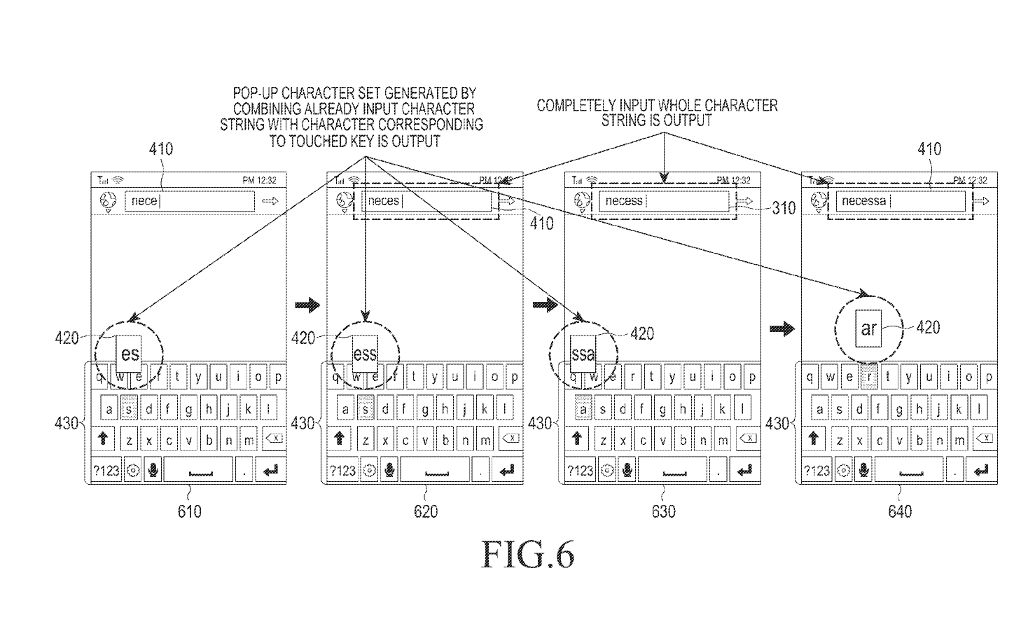

The operation of the character input processor 290 will be described below with reference to FIGS. 4, 5 and 6. FIG. 4 is a flowchart illustrating an operation of the character input processor according to an embodiment of the present invention, and FIGS. 5 and 6 illustrate character input screens according to an embodiment of the present invention.

In a service requiring character input, the portable device 100 provides a character input UI through the touch screen unit 200. As noted from the screens illustrated in FIG. 5, the character input UI includes a character display area 410, a touch keypad 430, and pop-up characters 420. If there is no user touch input, a pop-up character or pop-up character set 420 is not displayed on a screen.

Referring to FIG. 4, after the character input UI is displayed, the touch input receiver 220 of the character input processor 290 awaits reception of a user's key touch input in step 301. Upon generation of a key touch on the touch panel 210, for example when a user touches a key with his or her finger, the touch input receiver 220 senses the key touch and provides a touch input signal corresponding to the key touch to the key value acquirer 230 in step 303.

In step 305, the key value acquirer 230 acquires a key value, that is, a character corresponding to the touched key and provides the key value to the pop-up character generator 260.

If there is an already input character string, the pop-up character generator 260 retrieves the character string from the input character string memory 240 in step 307 and generates a pop-up character set in step 309.

A pop-up character set may be generated by taking a predetermined number of characters from a character string displayed in the character display area 410, starting with the last character. Specifically, in the presence of characters stored in the input character string memory 240, the number of characters that the pop-up character generator 260 selected from among the stored characters is determined according to a character combination rule.

If the same character is repeated in the stored characters, the number of acquired characters may be changed, for example, increased to the number of the repeated characters. For example, if no character was input previously or the last touch input is a space from the space bar, the pop-up character generator 260 generates the character received from the key value acquirer 230 as a pop-up character without acquiring any character from the input character string memory 240 and configures a touch pop-up with the pop-up character.

In the presence of any previously input character, in other words, in the presence of any character stored in the input character string memory 240, the pop-up character generator 260 determines a character to be acquired from the input character string memory 240 according to the last character stored in the input character string memory 240, the character received from the key value acquirer 230, and a character combination rule related to the received character.

If the type of the last stored character is different from that of the received character, for example, if the last stored character is a number and the received character is a letter, the pop-up character generator 260 generates the received character as a pop-up character.

If both the last stored character and the received character are letters, the pop-up character generator 260 determines a character to be acquired from the input character string memory 240 according to the character combination rule related to the received character.

For example, if the last stored character is a Korean letter and the received character is an English letter, the Korean letter cannot be combined with the English letter according to an English character combination rule. Therefore, the pop-up character generator 260 generates the received character as a pop-up character without acquiring any character from the input character string memory 240.

If the last stored character and the received character are in the same language, the pop-up character generator 260 determines a character to be acquired from the input character string memory 240 according to a character combination rule related to that language.

For example, in the Korean language, the pop-up character generator 260 acquires characters from the input character string memory 240, starting with the last stored character in order to generate a complete composite character by combining the acquired characters with the received character. The complete composite character refers to a syllable obtained by combining a consonant with a vowel. If a complete composite character “ [symbol] ” is stored in the input character string memory 240 and a consonant “ [symbol] ” is received from the key value acquirer 230, “ [symbol] ” is generated as a pop-up character.

If last characters stored in the input character string memory 240 form a complete composite character and a character to be combined with the final consonant of a syllable is received from the key value acquirer 230, the pop-up character generator 260 acquires the final consonant of the last stored complete composite character and generates a pop-up character set by combining the acquired final consonant with the received character. For example, if “ [symbol] ” is the last stored character set and a vowel “ [symbol] ” is the received character, the pop-up character generator 260 reads a consonant “∘” from the input character string memory 240 and combines the consonant “ [symbol] ” with the vowel “ [symbol] ”, thus producing a pop-up character set “ [symbol] ”.

If the last stored character is an incomplete character and a character to be combined with an incomplete character is received from the key value acquirer 230, the pop-up character generator 260 acquires the incomplete character from the input character string memory 240 and generates a pop-up character set by combining the incomplete character with the received character. For example, if the last stored character is a consonant “ [symbol] ” and the received character is a vowel “ [symbol] ”, “ [symbol] ” is generated as a pop-up character set.

If the last stored character is an incomplete character and the received character is not supposed to be combined with an incomplete character, the pop-up character generator 260 acquires the incomplete character and simply concatenates the received character to the incomplete character, thus creating a pop-up character set. For instance, if the last stored character is a consonant “ [symbol] ” and the received character is also the consonant “ [symbol] ”, the pop-up character set is “ [symbol] ”.

As described above, the pop-up character generator 260 may generate a pop-up character set according to various character combination rules and configures a touch pop-up with the pop-up character set.

Referring to FIG. 4 again, the pop-up character output unit 270 outputs the pop-up character set to display 280 which displays the touch pop-up generated in step 309 in the vicinity of the user-touched key in step 311.

For example, when the user touches a key corresponding to a consonant “ [symbol] ” with no character displayed in the character display area 410, the key value acquirer 230 acquires the consonant “ [symbol] ” as a key value and outputs the consonant “ [symbol] ” to the pop-up character generator 260 in steps 301 through 305. Because there is no previously input character, the pop-up character generator 260 generates a touch pop-up including the consonant “ [symbol] ” and outputs the touch pop-up to the pop-up character output unit 270. Thus, the touch pop-up 420 including the consonant “ [symbol] ” is displayed near to the key corresponding to the consonant “ [symbol] ” on a screen 510.

When the user touches a key corresponding to a vowel “ [symbol] ” with the consonant “ [symbol] ” displayed in the character display area 410, the key value acquirer 230 acquires the vowel “ [symbol] ” as a key value and outputs the vowel “ [symbol] ” to the pop-up character generator 260 in steps 301 through 305. The pop-up character generator 260 acquires the previously input character, “ [symbol] ” from the input character string memory 240 and combines the consonant “ [symbol] ” with the vowel “ [symbol] ”, thus producing a pop-up character set “ [symbol] ”. Then the pop-up character generator 260 generates a touch pop-up 420 including the pop-up character set “ [symbol] ” and outputs the touch pop-up to the pop-up character output unit 270. Thus, the touch pop-up including the character set “ [symbol] ” is displayed near to the key corresponding to the vowel “ [symbol] ” on a screen 520.

Referring to FIG. 4 again, with the touch pop-up displayed, the character input processor 290 awaits generation of an additional user's touch input in step 313. Display of a touch pop-up means that the user maintains the touch state after touching the touch panel 210 in step 303. An additional touch input may be triggered, for example, by removing a user's finger from the touch panel 210 and thus releasing the touch or moving from the initial touched key position without removing the user's finger.

Upon sensing generation of an additional touch input, the touch input receiver 220 determines whether the additional touch input is a touch key input cancellation in step 315. When the user moves from the initial touched key position, while still touching the touch panel 210, key input cancellation occurs. When confirming the key input cancellation, the key value acquirer 230 outputs a key input cancel signal to the pop-up character generator 260 and then awaits reception of a new key touch in step 301. Upon receipt of the key input cancel signal, the pop-up character generator 260 outputs a pop-up display discontinuation signal to the pop-up character output unit 270 to thereby discontinue displaying the current touch pop-up.

If the additional touch input is not a touch input cancellation, the key value acquirer 230 determines whether the key touch input has been completed in step 317. When the user removes his or her finger from the touch panel 210, the key input is completed. If the additional touch input is key input completion, the key value acquirer 230 provides the character acquired in step 305 to the input character string memory 240 and outputs a key input complete signal to the pop-up character generator 260. The pop-up character generator 260 outputs a pop-up display discontinuation signal to the pop-up character output unit 270 to thereby discontinue displaying the current touch pop-up.

In step 319, the input character string memory 240 stores the character received from the key value acquirer 230 in combination with an already input character string and outputs the stored character string to the input character string output unit 250. Thus, the input character string output unit 250 updates the screen with the received character string in step 321.

For example, if the user removes his or her finger from the key corresponding to the vowel “ [symbol] ” with the touch pop-up including the complete character set “ [symbol] ” displayed on the screen 520, it is determined that the key input has been completed and thus the touch pop-up with the character set “ [symbol] ” disappears. The key value acquirer 230 outputs the vowel “ [symbol] ” to the input character string memory 240. Then the input character string memory 240 combines the previously stored consonant “ [symbol] ” with the vowel “ [symbol] ” into the character set “ [symbol] ” and displays the character set “ [symbol] ” in the character display area 410.

When the user subsequently touches a key corresponding to a consonant “ [symbol] ”, the pop-up character generator 260 produces a pop-up character set “ [symbol] ” by combining the stored character set “ [symbol] ” with the consonant “ [symbol] ” and a touch pop-up with the pop-up character set “ [symbol] ” is displayed on a screen 530.

If the user changes the touched position with the pop-up character set “ [symbol] ” displayed on the screen 530, the touch pop-up is no longer displayed and the character display area 410 is not updated.

When the user releases the touch with the touch pop-up including the pop-up character set “ [symbol] ” displayed on the screen 530, the character set “ [symbol] ” is displayed in the character display area 410. Subsequently, when the user touches another letter key, for example, a key corresponding to a consonant “ [symbol] ”, a touch pop-up including the pop-up character “ [symbol] ” is displayed on a screen 540.

FIG. 6 illustrates an example of inputting English letters. In this embodiment, upon generation of a new key touch input in the presence of any previously input character, the pop-up character generator 260 basically reads the last stored character from the input character string memory 240 in order to generate a pop-up character set. Then the pop-up character generator 260 generates a pop-up character set by concatenating the character corresponding to the new key touch input, that is, the character received from the key value acquirer 230, to the character acquired from the input character string memory 240 and displays the pop-up character set.

If the last stored character is identical to the received character, the pop-up character generator 260 acquires two characters from the input character string memory 240 and concatenates the received character to the acquired characters, thereby producing a pop-up character set.

In another example, if the last stored character and the second to last character are identical, that is, if the same character is repeatedly stored, the pop-up character generator 260 acquires the stored plural characters from the input character string memory 240 and concatenates the received character to the acquired characters, thereby producing a pop-up character set.

FIG. 6 illustrates such an example. With “nece” displayed in the character display area 410, a user touches a key corresponding to ‘s’ on a screen 610. In other words, while “nece” is stored in the input character string memory 240, when the user touches the key to which “s” is assigned, the key value acquirer 230 outputs the letter “s” to the pop-up character generator 260. Since the two last letters “e” and “s” stored in the input character string memory 240 are different, the pop-up character generator 260 acquires the last stored letter “e” from the input character string memory 240 and generates and displays a pop-up character set “es” 420.

With “neces” displayed in the character display area 410 due to the input of the letter “s” on the screen 610, the user touches the key corresponding to ‘s’ on a screen 620. In other words, while “neces” is stored in the input character string memory 240, when the user touches the key to which “s” is assigned, the key value acquirer 230 outputs the letter “s” to the pop-up character generator 260. Since the last stored letter “s” and the received letter “s” are identical, the pop-up character generator 260 acquires the last two stored letters “e” and “s” and generates and displays a pop-up character set “ess”.

With “necess” displayed in the character display area 410 due to the input of the letter “s” on the screen 620, the user touches a key corresponding to ‘a’ on a screen 630. Then the key value acquirer 230 outputs the letter “a” to the pop-up character generator 260. Since the same letter “s” is repeatedly stored as last letters in the input character string memory 240, the pop-up character generator 260 acquires the last character string “ss” and generates and displays a pop-up character set “ssa” as a touch pop-up 420.

With “necessa” displayed in the character display area 410 due to the input of the letter “a” on the screen 630, the user has touched a key corresponding to ‘r’ on a screen 640. Then a pop-up character set “ar” is generated and displayed as a touch pop-up in a similar manner as on the screen 610.

As is apparent from the above description, the present invention advantageously allows a user to confirm a character string yet to be completed as well as a character corresponding to a touched key on a touch keypad by combining the character corresponding to the touched key with an already stored character string. Therefore, redundant inputs of the same key or loss of a key input can be prevented. In addition, since much of a process for verifying an input character string can be omitted, inconvenience caused by the need for repeatedly shifting a user's attention between the keypad and an input character string can be reduced or eliminated. As a consequence, the accuracy, speed, and user convenience of character input on a touch keypad can be increased.

While it has been described that a pop-up character set is generated only with a character acquired by the key value acquirer 230 according to a character combination rule in an embodiment of the present invention, it may be further contemplated as another embodiment that at least one character stored in the input character string memory 240 is always included in a pop-up character set. Accordingly, the scope of the invention should be determined by the appended claims and their equivalents, not by the above description, and all changes falling within the meaning and equivalency range of the appended claims are intended to be embraced therein.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A key input method using a touch keypad with a plurality of keys, the method comprising:
acquiring, upon detection of a user's touch on one of the plurality of keys, a character corresponding to the touched key;
generating a pop-up character set using the acquired character and a character which has been completely input before the user's touch and displayed in an input character display area of a display; and
displaying a touch pop-up including the pop-up character set in the vicinity of the touched key on the display.

2. The key input method of claim 1, wherein generating the pop-up character set comprises:
determining a character to be combined with the acquired character from among characters displayed in the input character display area according to a last character of the displayed characters and a character combination rule related to the acquired character; and
generating the pop-up character set by combining the determined character with the acquired character according to the character combination rule.

3. The key input method of claim 2, further comprising, upon detection of completion of the user's touch input of the one key, combining the last displayed character with the acquired character, updating the displayed characters with the combined characters, and displaying the updated characters in the input character display area.

4. The key input method of claim 3, further comprising, upon detection of completion of the user's touch input of the one key, discontinuing display of the touch pop-up.

5. The key input method of claim 4, wherein the character is one of an alphabetical letter, a number, and a symbol.

6. The key input method of claim 3, wherein if the displayed characters and the acquired character are from the Korean language, determining a character to be combined with the acquired character comprises determining the character to be combined with the acquired character from among the displayed characters, sequentially starting with the last displayed character to complete the acquired character as a syllable.

7. The key input method of claim 3, wherein if the same character is repeatedly displayed at the end of the displayed characters, determining a character to be combined with the acquired character comprises determining the repeated displayed characters as characters to be combined with the acquired character.

8. The key input method of claim 1, wherein the pop-up character set includes a last character of the displayed characters.

9. A key input apparatus using a touch keypad with a plurality of keys, the apparatus comprising:
a touch panel;
a display under the touch panel, for displaying the touch keypad; and
a character input processor for acquiring, upon detection of a user's touch on one key of the plurality of keys on the touch panel, a character corresponding to the touched key, generating a pop-up character set using the acquired character and a character which has been completely input before the user's touch and displayed in an input character display area of the display, and displaying a touch pop-up including the pop-up character set in the vicinity of the touched key.

10. The key input apparatus of claim 9, wherein the character input processor determines a character to be combined with the acquired character from among characters displayed in the input character display area according to a last character of the displayed characters and a character combination rule related to the acquired character in order to generate the pop-up character set, and generates the pop-up character set by combining the determined character with the acquired character according to the character combination rule.

11. The key input apparatus of claim 10, wherein upon detection of completion of the user's touch input of the one key, the character input processor combines the last displayed character with the acquired character, updates the displayed characters with the combined characters, and displays the updated characters in the input character display area.

12. The key input apparatus of claim 11, wherein upon detection of completion of the user's touch input of the one key, the character input display discontinues display of the touch pop-up.

13. The key input apparatus of claim 12, wherein the character is one of an alphabetical letter, a number, and a symbol.

14. The key input apparatus of claim 11, wherein if the displayed characters and the acquired character are from the Korean language, the character input processor determines the character to be combined with the acquired character from among the displayed characters, sequentially starting with the last displayed character to complete the acquired character as a syllable.

15. The key input apparatus of claim 11, wherein if the same character is repeatedly displayed at the end of the displayed characters, the character input processor determines the repeated displayed characters as characters to be combined with the acquired character.

16. The key input apparatus of claim 9, wherein the pop-up character set includes a last character of the displayed characters.
